(19) United States
(12) Patent Application Publication
(10) Pub. No.: US 2022/0307935 A1
(43) Pub. Date: Sep. 29, 2022

(54) TIME DELAYED LEAK INDICATOR FOR A REFRIGERATOR APPLIANCE

(71) Applicant: Haier US Appliance Solutions, Inc., Wilmington, DE (US)

(72) Inventors: Habib Baydoun, Dearborn Heights, MI (US); Gregory Sergeevich Chernov, Louisville, KY (US); Jianwu Li, Louisville, KY (US); Zhibin Zhang, Dayton, OH (US)

(21) Appl. No.: 17/211,160

(22) Filed: Mar. 24, 2021

(51) Int. Cl. G01M 3/04; F25D 23/12; B01D 29/33; B01D 35/143

(52) U.S. Cl. CPC G01M 3/04; F25D 23/126; B01D 29/33; B01D 35/1435; F25D 2323/121

(57) ABSTRACT

A leak indicator includes a substrate comprising a permeable material with an immobilized reactant embedded in the substrate at a fixed location and a mobile reactant disposed at an initial location on the substrate. The initial location of the mobile reactant is spaced apart from the fixed location of the immobilized reactant. The mobile reactant is transported through the substrate by water to the fixed location of the immobilized reactant. The mobile reactant and the immobilized reactant interact to indicate a leak when the mobile reactant reaches the immobilized reactant.

### FIELD OF THE INVENTION

The present subject matter relates generally to systems for detecting leaks, such as systems for detecting leaks in a water filter or household appliance.

### BACKGROUND OF THE INVENTION

One or more of several various appliances which may be found in a domestic setting or household use and/or treat water for useful purposes, such as for making ice, drinking, cleaning dishes, washing laundry, etc., and may include filtering or otherwise treating the water either in combination with another function such as the foregoing examples or as a stand-alone function. One example water-using appliance is a refrigerator appliance which may provide water for drinking and/or may draw water to freeze and thereby form ice cubes. In some instances, however, the water may escape from an intended flow path and such leaks can result in undesired effects.

Continuing the refrigerator example, refrigerator appliances generally include a cabinet that defines a chilled chamber. A wide variety of food items may be stored within the chilled chamber. The low temperature of the chilled chamber relative to the ambient atmosphere assists with increasing a shelf life of the food items stored within the chilled chamber.

In addition, refrigerator appliances commonly include dispensing assemblies for providing water and/or ice to the user, and water filter assemblies are frequently used to filter such water before use. For example, certain water filter assemblies include a filter cartridge having a housing and a filter medium therein. Unfiltered water flows into the housing of the filter cartridge and filtered water flows out of the housing of the filter cartridge. The filter medium may be an activated carbon block, a pleated polymer sheet, a spun cord material, or a melt blown material. The filter medium is positioned within the housing and filters water passing therethrough.

Water leaks can form or develop at one or more various locations in or around the water filter assembly, such as where the filter cartridge mounts to a manifold. As an example, such leaks can develop if the water filter assembly is installed incorrectly or is exposed to relatively high water pressures or freezing conditions. Such leaks can negatively affect operation of the water filter assembly and/or the refrigerator appliance and can cause damage if not prevented. Such leaks can also be difficult to detect. In particular, water filter assemblies are often positioned in relatively remote locations within refrigerator appliances such that visually monitoring the water filter assemblies for leaks can be difficult or infrequent.

Accordingly, improved features for detecting water leaks would be beneficial.

### BRIEF DESCRIPTION OF THE INVENTION

Aspects and advantages of the invention will be set forth in part in the following description, or may be apparent from the description, or may be learned through practice of the invention.

In an exemplary embodiment, a household appliance is provided. The household appliance includes a water filter and a leak indicator positioned on an external surface of the water filter. The leak indicator includes a substrate comprising a permeable material with an immobilized reactant embedded in the substrate at a fixed location and a mobile reactant disposed at an initial location on the substrate. The initial location of the mobile reactant is spaced apart from the fixed location of the immobilized reactant. The mobile reactant is transported through the substrate by water to the fixed location of the immobilized reactant. The mobile reactant and the immobilized reactant interact to indicate a leak when the mobile reactant reaches the fixed location of the immobilized reactant.

In another exemplary embodiment, a leak indicator is provided. The leak indicator includes a substrate comprising a permeable material with an immobilized reactant embedded in the substrate at a fixed location and a mobile reactant disposed at an initial location on the substrate. The initial location of the mobile reactant is spaced apart from the fixed location of the immobilized reactant. The mobile reactant is transported through the substrate by water to the fixed location of the immobilized reactant. The mobile reactant and the immobilized reactant interact to indicate a leak when the mobile reactant reaches the fixed location of the immobilized reactant.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to an exemplary embodiment of the present subject matter.

FIG. 2 provides a perspective view of the refrigerator appliance of FIG. 1.

FIG. 3 provides a front view of the refrigerator appliance of FIG. 1 with doors in an open position.

FIG. 4 provides a simplified section view of a water filter with a leak indicator according to one or more embodiments of the present disclosure which may be incorporated into a refrigerator appliance such as the exemplary refrigerator appliance of FIG. 1.

FIG. 5 provides a schematic illustration of features, including the water filter of FIG. 4, for detecting a leak in a refrigerator appliance such as the exemplary refrigerator appliance of FIGS. 1 through 3 according to one or more embodiments of the present subject matter.

FIG. 6 illustrates a leak indicator according to one or more embodiments of the present subject matter with a mobile reactant thereof in an initial location.

FIG. 7 illustrates the leak indicator of FIG. 6 with the mobile reactant carried to an intermediate position by water.

FIG. 8 illustrates the leak indicator of FIG. 6 with the mobile reactant and the immobilized reactant interacting to indicate a leak.

FIG. 9 illustrates a leak indicator according to one or more additional embodiments of the present subject matter, where the leak indicator includes multiple pairs of reactants, with the mobile reactants thereof each in an initial location.

FIG. 10 illustrates the leak indicator of FIG. 9 with a first and second pair of reactants interacting to indicate a leak and additional pairs of reactants with the mobile reactants thereof in an intermediate position.

FIG. 11 illustrates the leak indicator of FIG. 9 with each pair of reactants interacting to indicate a leak.

FIG. 12 illustrates a leak indicator according to one or more additional embodiments of the present subject matter, where the leak indicator includes multiple mobile reactants and multiple immobilized reactants, where the reactants are arranged to detect leaks along multiple directions, with the mobile reactants thereof each in an initial location.

FIG. 13 illustrates the leak indicator of FIG. 12 with the mobile reactants thereof in a first intermediate position and interacting with the immobilized reactant at a first fixed location to indicate a leak after a first time duration of the leak.

FIG. 14 illustrates the leak indicator of FIG. 12 with the mobile reactants thereof in a second intermediate position and interacting with the immobilized reactant at a second fixed location to indicate the leak at a second time duration of the leak after the first time duration.

FIG. 15 illustrates the leak indicator of FIG. 12 with the mobile reactants thereof in a third intermediate position and interacting with the immobilized reactant at a third fixed location to indicate the leak after a third time duration of the leak following the second time duration.

### DETAILED DESCRIPTION

Reference now will be made in detail to embodiments of the invention, one or more examples of which are illustrated in the drawings. The detailed description uses numerical and letter designations to refer to features in the drawings. Like or similar designations in the drawings and description have been used to refer to like or similar parts of the disclosure. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

The present disclosure relates generally to leak indicators, which may be used with various household appliances and/or water filters which may be connected to such household appliances. For example, the household appliance may be an appliance which provides potable water, such as for drinking or making ice, or may be a water treatment appliance, such as a water softener, point of use filtration system, or point of entry filtration system. In such embodiments, the household appliance may have a water filter cartridge or assembly connected thereto and/or therein, and a leak indicator may be provided on an external surface of the water filter. In additional embodiments, the water filter with a leak indicator thereon may be connected to or used with any suitable device. In some embodiments, the household appliance may be any water-using household appliance, such as a dishwashing appliance or a clothes washer appliance, with or without a water filter, and the leak indicator may be positioned on any suitable external surface, such as an external surface of a cabinet or housing of the household appliance.

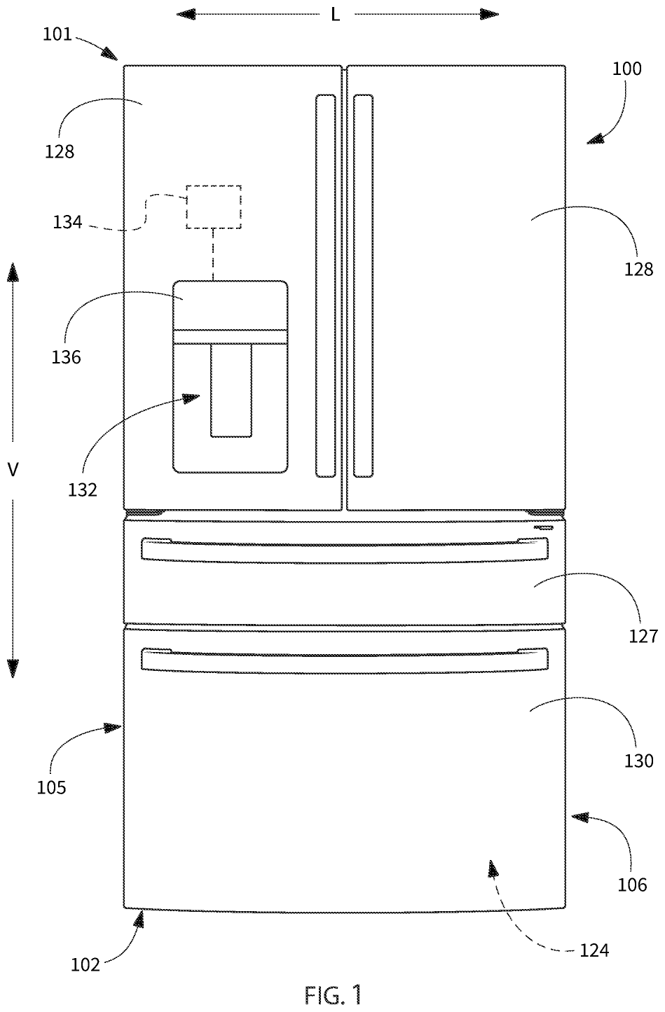

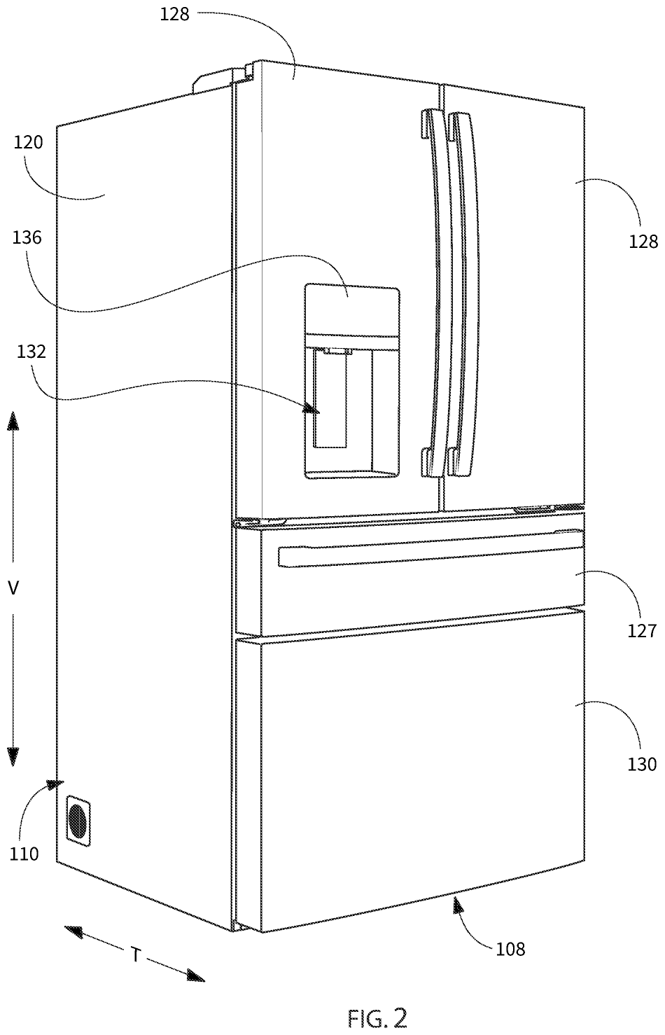

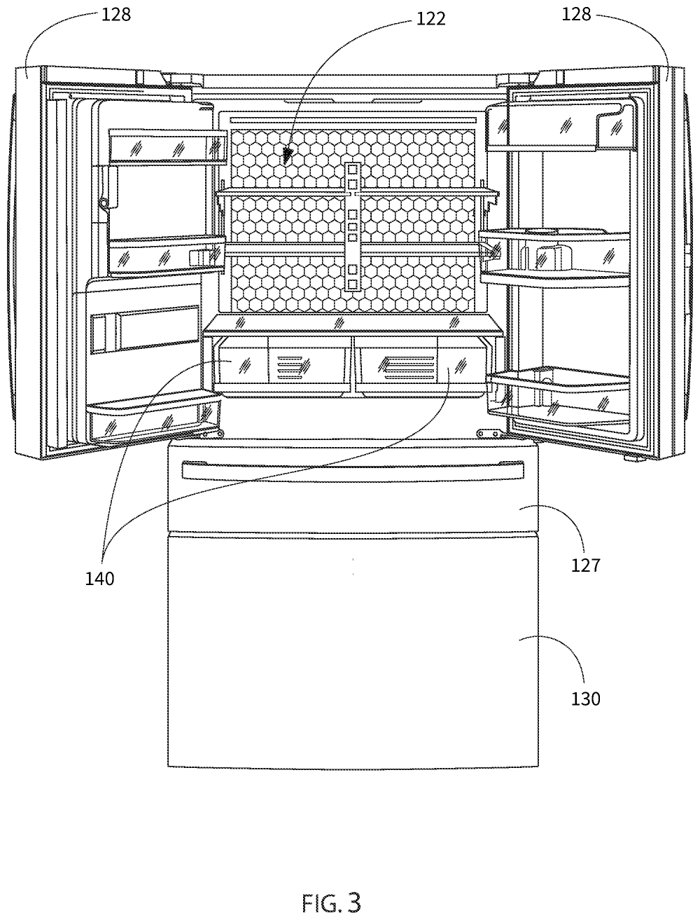

FIG. 1 is a front view of an exemplary household appliance according to one or more embodiments of the present disclosure, where the household appliance is a refrigerator appliance 100. FIG. 2 is a perspective view of the refrigerator appliance 100. FIG. 3 is a front view of the refrigerator appliance 100 with fresh food doors 128 thereof in an open position. Refrigerator appliance 100 extends between a top 101 and a bottom 102 along a vertical direction V. Refrigerator appliance 100 also extends between a first side 105 and a second side 106 along a lateral direction L. As shown in FIG. 2, a transverse direction T may additionally be defined perpendicular to the vertical and lateral directions V, L. Refrigerator appliance 100 extends along the transverse direction T between a front portion 108 and a back portion 110.

Refrigerator appliance 100 includes a cabinet or housing 120 defining an upper fresh food chamber 122 (FIG. 3) and a lower freezer chamber or frozen food storage chamber 124 (FIG. 1) arranged below the fresh food chamber 122 along the vertical direction V. Because the freezer chamber 124 is positioned below the fresh food chamber 122, refrigerator appliance 100 is generally referred to as a bottom mount refrigerator. In an exemplary embodiment, housing 120 also defines a mechanical compartment (not shown) for receipt of a sealed cooling system (not shown). Using the teachings disclosed herein, one of ordinary skill in the art will understand that the present technology can be used with other types of refrigerators (e.g., side-by-sides) or a freezer appliance as well. Consequently, the description set forth herein is for illustrative purposes only and is not intended to limit the technology in any aspect.

Refrigerator doors 128 are each rotatably hinged to an edge of housing 120 for accessing fresh food chamber 122. It should be noted that while two doors 128 in a “French door” configuration are illustrated, any suitable arrangement of doors utilizing one, two, or more doors is within the scope and spirit of the present disclosure. A freezer door 130 is arranged below refrigerator doors 128 for accessing freezer chamber 124. In the exemplary embodiment, freezer door 130 is coupled to a freezer drawer (not shown) slidably mounted within freezer chamber 124. An auxiliary door 127 is also provided, and the auxiliary door 127 may be slidably mounted within an auxiliary chamber (not shown) which is positioned between the fresh food storage chamber 122 and the freezer chamber 124. As may be seen in FIG. 3, a plurality of food storage drawers 140 may be disposed within the fresh food storage chamber 122. Although not specifically labelled, additional example food storage components such as bins and shelves may also be seen in FIG. 3.

Operation of the refrigerator appliance 100 can be regulated by a controller 134 (FIG. 1) that is operatively coupled to a user interface panel 136. Interface panel 136 provides selections for user manipulation of the operation of refrigerator appliance 100 to modify environmental conditions therein, such as temperature selections, etc. In some embodiments, user interface panel 136 may be proximate a dispenser assembly 132. In response to user manipulation of the user interface panel 136, the controller 134 operates various components of the refrigerator appliance 100. Operation of the refrigerator appliance 100 can be regulated by the controller 134, e.g., controller 134 may regulate operation of various components of the refrigerator appliance 100 in response to programming and/or user manipulation of the user interface panel 136.

The controller 134 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. It should be noted that controllers 134 as disclosed herein are capable of and may be operable to perform any methods and associated method steps as disclosed herein.

The controller 134 may be positioned in a variety of locations throughout refrigerator appliance 100. In the illustrated embodiment, the controller 134 may be located within one of the doors 128. In such an embodiment, input/output (“I/O”) signals may be routed between the controller and various operational components of refrigerator appliance 100. In one embodiment, the user interface panel 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. For example, the user interface 136 may include a touchscreen providing both input and display functionality. The user interface 136 may be in communication with the controller via one or more signal lines or shared communication busses.

Using the teachings disclosed herein, one of ordinary skill in the art will understand that the present subject matter can be used with various household appliances and/or water filters, including other types of refrigerators such as a refrigerator/freezer combination, side-by-side, bottom mount, compact, and any other style or model of refrigerator appliance. Additional possible example household appliances include standalone ice makers and water treatment systems (as mentioned above), as well as household appliances which provide water that is not necessarily for consumption, such as dishwashing appliances and clothes washer appliances, e.g., with or without a water filter, as mentioned above. Accordingly, other configurations of refrigerator appliance 100 could be provided, it being understood that the configurations shown in the accompanying FIGS. and the description set forth herein are by way of example for illustrative purposes only.

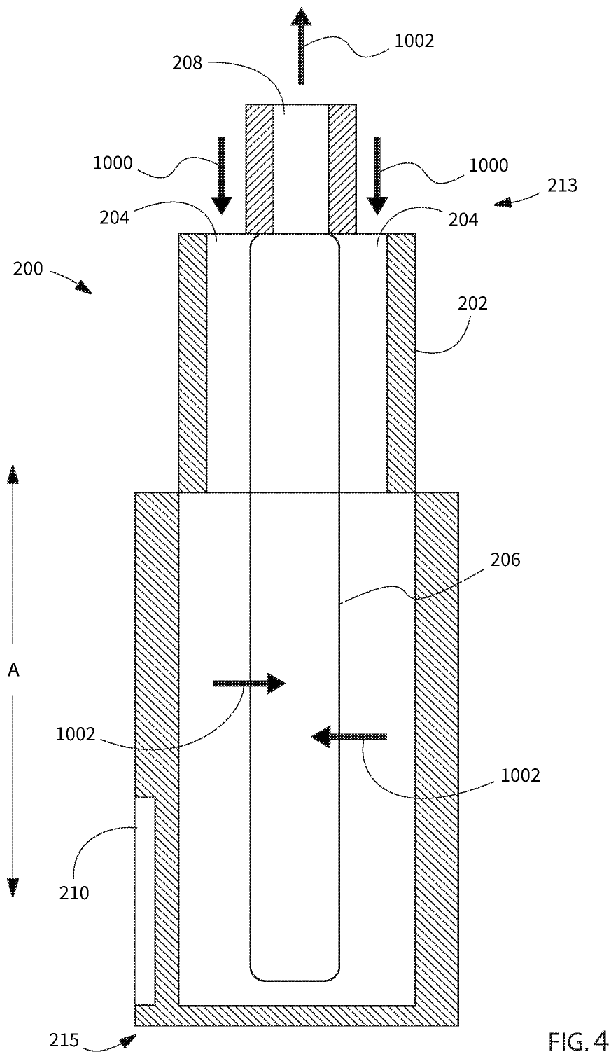

In various embodiments, e.g., as illustrated in FIG. 4, the present disclosure may include a water filter 200. In some example embodiments, the water filter 200 may be connected to a household appliance such as the refrigerator appliance 100. For example, the water filter 200 may be coupled to a water supply line and/or a manifold (not shown) such that the water filter 200 receives a flow of water 1000, e.g., which may be referred to as raw or unfiltered water, from the water supply line and provides a flow of water 1002, e.g., filtered water, to a portion of the water supply line downstream of the filter 200 and/or various fixtures or components of a household appliance, e.g., the refrigerator appliance 100, such as an ice maker or water dispenser, etc., of the refrigerator appliance 100. The water filter 200 may include a housing 202 which defines an internal volume with an inlet 204 opening through the housing 202 into the internal volume and an outlet 208 from the internal volume. As illustrated in FIG. 4, unfiltered water 1000 may flow into the filter 200 via the inlet 204. The water may then pass through a filter medium 206, e.g., a membrane, activated carbon, or other suitable filter medium including combinations of more than one media, thereby producing filtered water 1002 which exits the water filter 200 via the outlet 208. The inlet 204 and the outlet 208 may be defined in a proximal end of 213 the water filter 200. The water filter 200 may also define an axial direction A and extend along the axial direction A from the proximal end 213 to a distal end 215. A leak indicator 210 may be positioned on or near the water filter 200, such as in an anticipated flow path of leaked water. In particular, the leak indicator 210 may be positioned on an external surface of the housing 202 of the water filter 200. As will be described in more detail below, the leak indicator 210 may react to the presence of water, such as by changing color, thereby providing a visual indication of a leak.

If or when a leak were to occur, the leak would most likely originate at the connection point between the water filter 200 and one or more adjoining component(s), e.g., a manifold, which may be a part of the household appliance, e.g., refrigerator appliance 100. Any such leak that may occur is also most likely to flow by gravity from the connection point. Thus, the leak indicator 210 may be positioned in an anticipated leak path along which a leak is most likely to travel, such as below the connection point between the water filter 200 and the refrigerator appliance 100 along the vertical direction V. For example, in some embodiments, the water filter 200 may be installed in the refrigerator appliance 100 such that the axial direction A is oriented along or generally parallel to the vertical direction V (FIGS. 1 and 2) defined by the refrigerator appliance 100. In such embodiments, the leak indicator 210 may be positioned below the proximal end 213 of the water filter 200, such as between the proximal end 213 and the distal end 215 along the axial direction A.

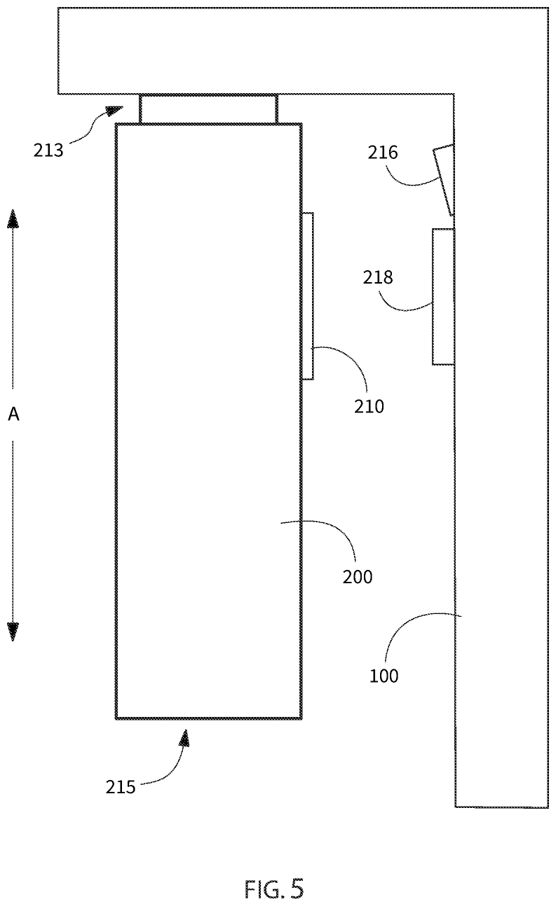

In some embodiments, e.g., as illustrated in FIG. 5, the household appliance, e.g., refrigerator appliance 100, may include additional features for detecting a leak. The features illustrated in FIG. 5 may be particularly advantageous when the water filter 200 is installed in a remote or difficult to access location which makes manual inspection of the leak indicator less convenient. As shown in FIG. 5, the water filter 200 may be coupled to the household appliance, e.g., refrigerator appliance 100, at the proximal end 213 of the water filter 200 with the leak indicator 210 attached to the external surface of the water filter 200 between the proximal end 213 of the water filter 200 and the distal end 215 along the axial direction A. In some embodiments, the refrigerator appliance 100 may also include an optical sensor 218 aligned with the leak indicator 210 for detecting leaks. For example, the optical sensor 218 may be positioned and configured to align with the leak indicator 210 on the water filter 200 when the water filter 200 is installed based on the position of the optical sensor 218 in relation to the connection point at which the proximal end 213 of the water filter 200 is coupled to the refrigerator appliance 100. For example, the optical sensor 218 may be positioned at a distance from the connection point between the water filter 200 and the refrigerator appliance 100 that is approximately equal to the distance between the leak indicator 210 and the proximal end 213 of the water filter 200. The optical sensor 218 may define a field of vision, as is generally understood by those of ordinary skill in the art, and the optical sensor 218 may be aligned with the leak indicator 210 in that the leak indicator 210 is within the field of vision of the optical sensor 218 when the water filter 200 is installed in and coupled to the refrigerator appliance 100. The optical sensor 218 may be in operative communication with, e.g., electrically coupled to, the controller 134. Thus, in embodiments where the leak indicator 210 provides a visual indication of a leak, such as by changing color, the optical sensor 218 may detect the visual indication, e.g., color change, and transmit a signal to the controller 134 in response to the detected leak. Such embodiments may also include a light source 216 which is positioned and configured to illuminate the leak indicator 210. For example, the light source 216 may be or include a light-emitting diode (LED). The light source 216 may be oriented towards the leak indicator 210, such that the light source 216, when activated, emits light towards, e.g., onto, the leak indicator 210. The light source 216 may enhance the accuracy of the optical sensor 218 with respect to detecting an indication of a leak on the leak indicator 210, e.g., the light source 216 may help the optical sensor 218 to see the leak indicator 210. In some embodiments, the light source 216 may be configured to turn on when the optical sensor 218 takes a color reading.

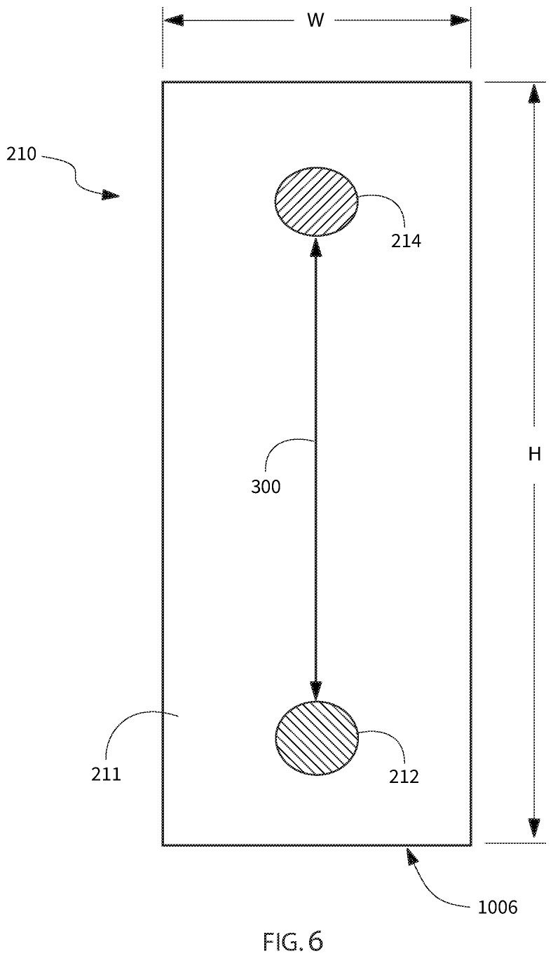

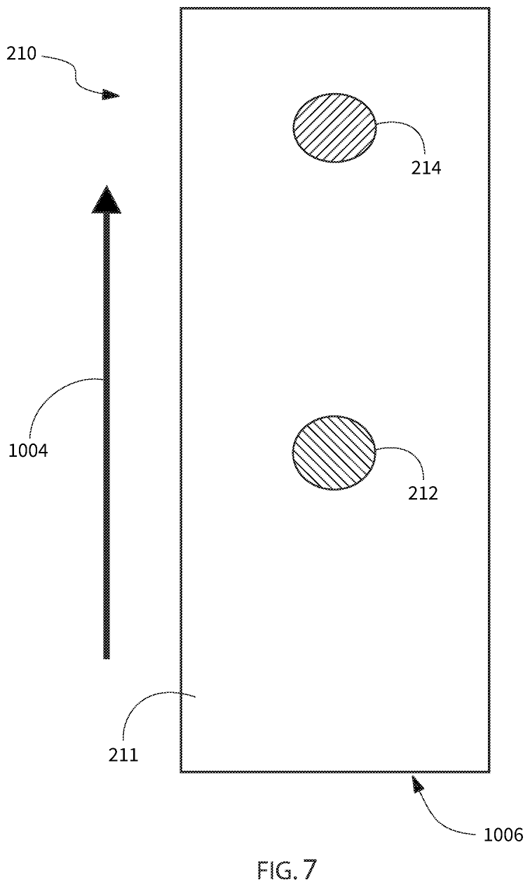

Turning now to FIG. 6, in some embodiments, the leak indicator 210 may include a substrate 211 with reactants on the substrate 211. The substrate may comprise a porous material, whereby water, e.g., leaked water, may flow through the substrate 211, such as by capillary flow. In some embodiments, the leak indicator 210 may initially encounter and/or be exposed to the leaked water at a water entry location 1006, which may be defined along part or all of one or more edges of the leak indicator 210. For example, the water entry location 1006 may be defined along an edge of the substrate 211 that is generally perpendicular to the anticipated leak direction 1004 (FIG. 7). The substrate 211 may define a height H which may be a major dimension, e.g., the largest dimension, of the substrate 211 and a width W which may be a minor dimension, e.g., smaller than the height H, of the substrate 211. The height H and the width W may be mutually perpendicular. It is to be understood that the substrate 211 also includes a thickness, e.g., in a direction into and out of the page in FIG. 6, which is generally the smallest dimension, e.g., less than each of the width W and the height H, of the substrate 211. The thickness of the substrate 211 is also mutually perpendicular with each of the width W and the height H of the substrate 211.

In some embodiments, the reactants on the substrate 211 may include an immobilized reactant 214 that is embedded in the substrate 211 at a fixed location and a mobile reactant 212 that is disposed at an initial location on the substrate 211. The immobilized reactant 214 may be embedded in the substrate 211 either physically or chemically (or combinations of both) in various embodiments. For example, the immobilized reactant 214 may be physically embedded in the substrate 211 in that the immobilized reactant 214 is physically absorbed within a matrix of the substrate 211, physically encapsulated within the substrate 211, and/or otherwise physically bound to the substrate 211. As additional examples, the immobilized reactant 214 may be chemically embedded in the substrate 211 or chemically bonded to the substrate 211, such as by a covalent bond. The chemical bond of the immobilized reactant 214 to the substrate 211 may advantageously prevent or minimize leaching of the immobilized reactant 214, thereby extending the shelf life of the leak indicator 210. The mobile reactant 212 is not fixed in place on the substrate 211, such that the initial location of the mobile reactant 212 is the location at which the mobile reactant 212 is deposed on the substrate 211 at the time the leak indicator 210 is produced, and the initial location is the location at which the mobile reactant 212 will remain unless and until water flows through the substrate 211, e.g., by capillary flow, such as from a leak which enters the substrate at a water entry location 1006 as described above. Thus, the mobile reactant 212 is not at a fixed location, whereas the immobilized reactant 214 is fixed in place in or on the substrate 211, e.g., the mobile reactant 212 may move or travel within and about the substrate 211 in the presence of water while the immobilized reactant 214 remains in the fixed location even in the presence of water.

Additionally, in at least some embodiments, the substrate 211 may consist of a single layer of material, e.g., a single layer of the porous material, such that the thickness of the substrate 211 is entirely defined by the single layer of the substrate 211 with the fixed location of the immobilized reactant 214 in the single layer and the initial location of the mobile reactant 212 in the single layer. In such embodiments, the mobile reactant 212 moves within and through the single layer, e.g., without traversing more than one layer of material.

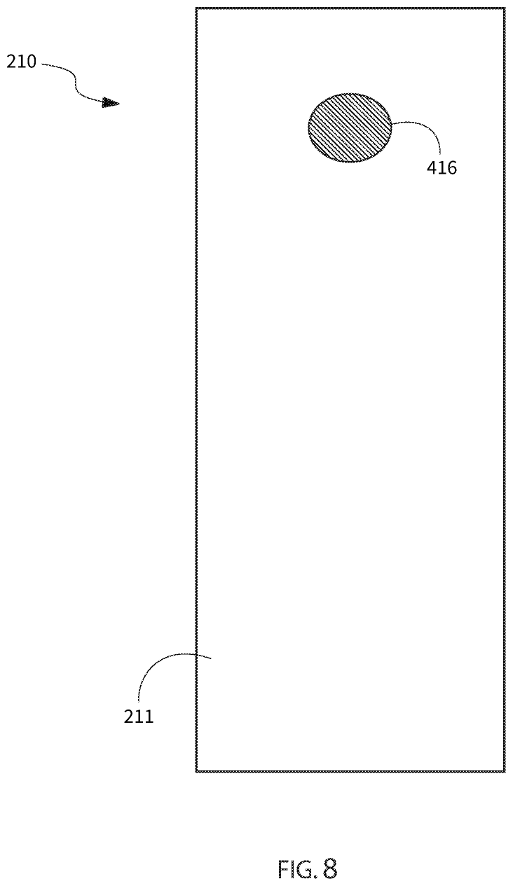

As illustrated in FIG. 6, the initial location of the mobile reactant 212 and the fixed location of the immobilized reactant 214 may be spaced apart by a first distance 300. For example, in some embodiments, the first distance 300 may be along or generally parallel to the height H of the substrate 211. The leak indicator 210 may thereby be a time-delayed leak indicator. For example, the indication of the leak may be created when the mobile reactant 212 and the immobilized reactant 214 interact, e.g., to create a product 416 as illustrated in FIG. 8 and described in more detail below, and the time delay may be equal to the time it takes for the mobile reactant 212 to travel the first distance 300, e.g., to be carried across the first distance 300 by water moving through the substrate 211 of the leak indicator 210. The time delay may advantageously avoid false positives or nuisance leak detections because a small or de minimis, insignificant leak or amount of water will not transport the mobile reactant 212 fully across the first distance 300. Thus, in some exemplary embodiments, the leak indicator may thereby be configured to indicate a time duration of the indicated leak, such as the presence of the reaction product 416 may indicate that the leak has occurred for at least as long as it takes for the leaked water to flow, e.g., by capillary flow, through the substrate 211 from the initial location of the mobile reactant 212 to the fixed location of the immobilized reactant 214.

In some embodiments, the leak indicator 210 may include a water insulating layer on at least a portion of the substrate 211. For example, the entire substrate 211 or at least one entire face of the substrate 211 may be covered with the water insulating layer. The water insulating layer may ensure that the substrate 211 is exposed to water only at specific locations. In some embodiments, the water insulating layer (or parts of it) may be made out of transparent material, e.g., in order to promote visibility of the reactant(s) 212, 214 and/or the product 416.

Turning now to FIG. 7, when water, e.g., leaked water from the water filter 200, encounters the leak indicator 210, the water may travel through the leak indicator 210, such as through the porous material thereof, along a direction 1004. For example, the leak indicator 210 may be oriented and positioned such that the direction 1004 lies along an anticipated or most likely leak path. Where the direction 1004 is generally parallel to the first distance 300, the mobile reactant 212 is transported through the porous material of the substrate 211 towards the immobilized reactant 214 by the water travelling in direction 1004. The mobile reactant 212 will thus traverse through a plurality of intermediate positions, e.g., one of which is illustrated in FIG. 7, between the initial position of the mobile reactant 212 and the fixed location of the immobilized reactant 214 during the time delay.

When the mobile reactant 212 reaches the immobilized reactant 214, e.g., as illustrated in FIG. 8, the mobile reactant 212 and the immobilized reactant 214 interact to create a product 416 and thereby indicate a leak. For example, the interaction of the mobile reactant 212 and the immobilized reactant 214 may provide a visual indication, such as may produce a color change, as a result of the water permeating the substrate 211 of the leak indicator 210 to the extent that the mobile reactant 212 traverses the first distance 300 and interacts with the immobilized reactant 214. Thus, the interaction of the mobile reactant 212 and the immobilized reactant 214 occurs as a result of the water flowing in direction 1004 (FIG. 7) at least as far as the first distance 300 and, as such, indicates the presence of a leak.

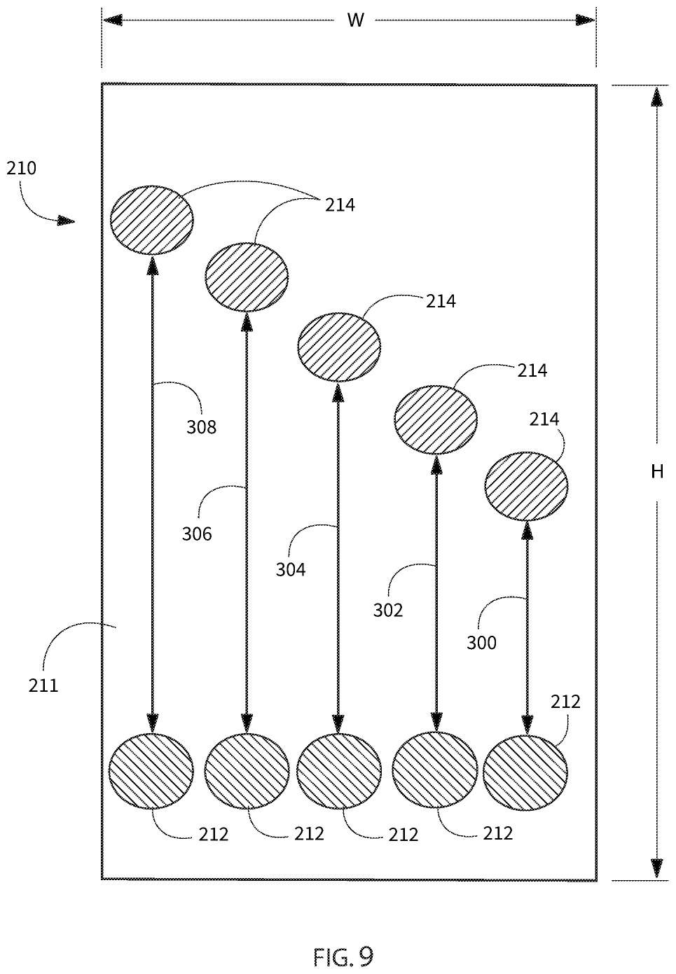

The mobile reactant 212 and the immobilized reactant 214 may constitute a pair of reactants. In some embodiments, the leak indicator 210 may include multiple pairs of reactants. For example, as illustrated in FIG. 9, the leak indicator 210 may include a plurality of mobile reactants 212 and a plurality of immobilized reactants 214. The plurality of mobile reactants 212 and the plurality of immobilized reactants 214 may collectively define multiple pairs or a plurality of pairs of reactants. For example, each mobile reactant 212 of the plurality of mobile reactants 212 may correspond to a respective one immobilized reactant 214 of the plurality of immobilized reactants 214, and each immobilized reactant 214 of the plurality of immobilized reactants 214 may correspond to a respective one mobile reactant 212 of the plurality of mobile reactants 212, such that there is a one-to-one correspondence between the plurality of mobile reactants 212 and the plurality of immobilized reactants 214. The reactants making up each pair of reactants may correspond to each other in that they are aligned along the height H of the leak indicator 210, e.g., the centerpoint of each mobile reactant 212 may be colinear with the centerpoint of the corresponding immobilized reactant 214 along a line that is generally parallel to the height H of the leak indicator 210.

Also as may be seen in FIG. 9, in such embodiments, the plurality of pairs of reactants may be spaced apart by diverse distances. For example, as illustrated in FIG. 9, the plurality of pairs of reactants may include a first mobile reactant 212 spaced apart from a first immobilized reactant 214 by a first distance 300, a second mobile reactant 212 spaced apart from a second immobilized reactant 214 by a second distance 302, a third pair of reactants spaced apart by a third distance 304, a fourth pair of reactants spaced apart by a fourth distance 306, and a fifth pair of reactants spaced apart by a fifth distance 308, where each distance 300, 302, 304, 306, and 308 is distinct from (e.g., not equal to) every other distance 300, 302, 304, 306, and 308. The five pairs of reactants illustrated in FIG. 9 are by way of example only, embodiments of the present disclosure which include multiple reactant pairs may also include two pairs, three pairs, four pairs, or more than five pairs of reactants. Moreover, the multiple pairs of reactants may be provided in various combinations spaced apart at diverse or equal distances, such as four pairs of reactants with two pairs spaced apart by a first distance and the other two pairs spaced apart by a second distance different from the first distance, etc.

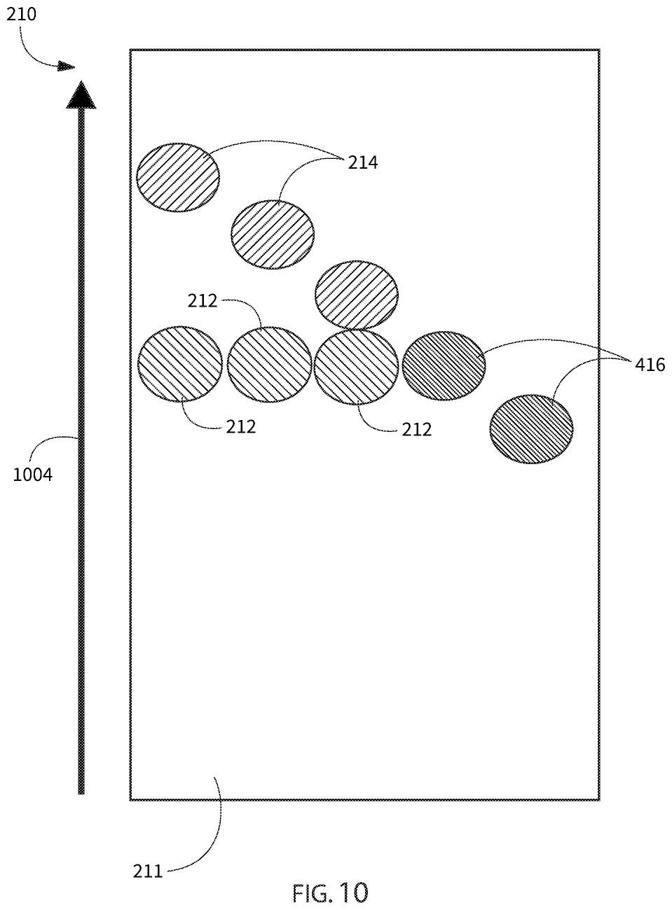

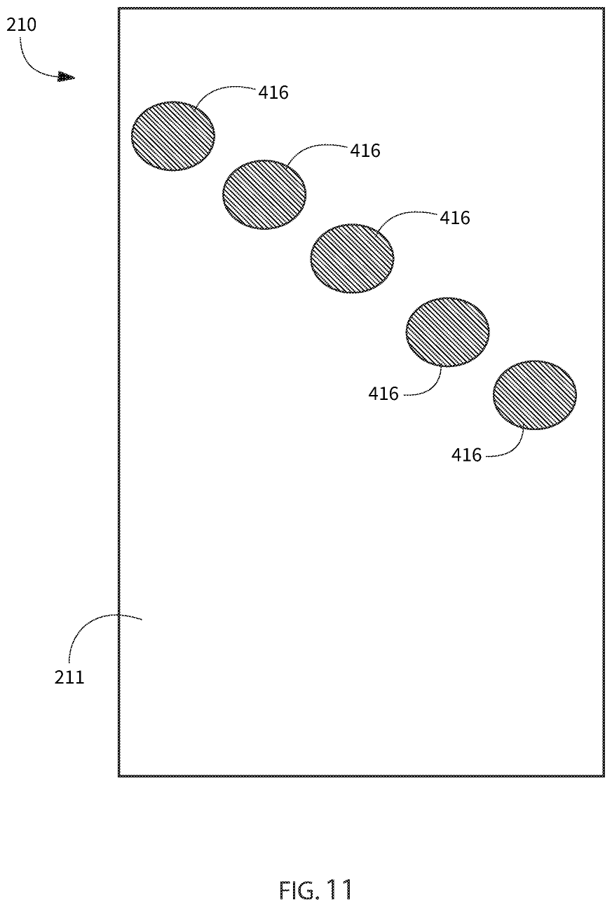

Providing multiple pairs of reactants spaced apart by at least two distinct distances may advantageously provide an estimate of how long the indicated leak has been occurring. For example, in the embodiment illustrated in FIG. 9 with five reactant pairs spaced apart by five distinct distances 300, 302, 304, 306, and 308, each distinct distance will provide a different time delay for each pair of reactants. For example, as water flows through the substrate 211 along direction 1004 (FIG. 10), the first mobile reactant 212 will traverse the first distance 300 in a first time and interact with the first immobilized reactant 214 at the first time, the second mobile reactant 212 will traverse the second distance 302 in a second time (longer than the first time where the second distance 302 is longer than the first distance 300) and interact with the second immobilized reactant 214 at the second time, and so forth. FIG. 10 illustrates an example where the leak has occurred and has flowed along the direction 1004 for a period of time that is longer than the first time and longer than the second time, but less than a third time delay that it takes for the third mobile reactant 212 to travel the third distance 304 and interact with the third immobilized reactant 214. Thus, the condition of the leak indicator 210 illustrated in FIG. 10 provides or indicates an estimate that the leak has occurred and that the leak began longer ago than the first or second times, but less than the third time. Further, as illustrated in FIG. 11, each pair of reactants will eventually interact if water continues to flow along direction 1004 through the substrate, e.g., if the leak continues, such as when the fifth mobile reactant 212 travels the fifth distance 308 over a fifth time delay, resulting in five products 416 which indicate the presence of the leak and provide an estimate of the duration of the leak. For example, the condition of the leak indicator 210 illustrated in FIG. 10 indicates the duration of the leak is less than the third time delay but more than the second time delay, whereas the condition of the leak indicator 210 illustrated in FIG. 11 indicates the duration of the leak is more than the fifth time delay.

The distance 300 (or each distance in embodiments with multiple reactant pairs) along which the pair(s) of reactants are spaced apart is generally parallel to the flow direction 1004. For example, the direction 1004 may be downward, e.g., along the vertical direction V, whereby leaked water originating from the connection point between the filter 200 and the refrigerator appliance 100 flows by gravity to the leak indicator 210. In some example embodiments, the axial direction A (see, e.g., FIG. 5) of the water filter 200 may be generally parallel to the vertical direction V, the flow direction 1004 may also be generally parallel to the axial direction A, and the distance(s) along which the reactant pair or pairs is or are spaced apart may be generally parallel to the axial direction A as well.

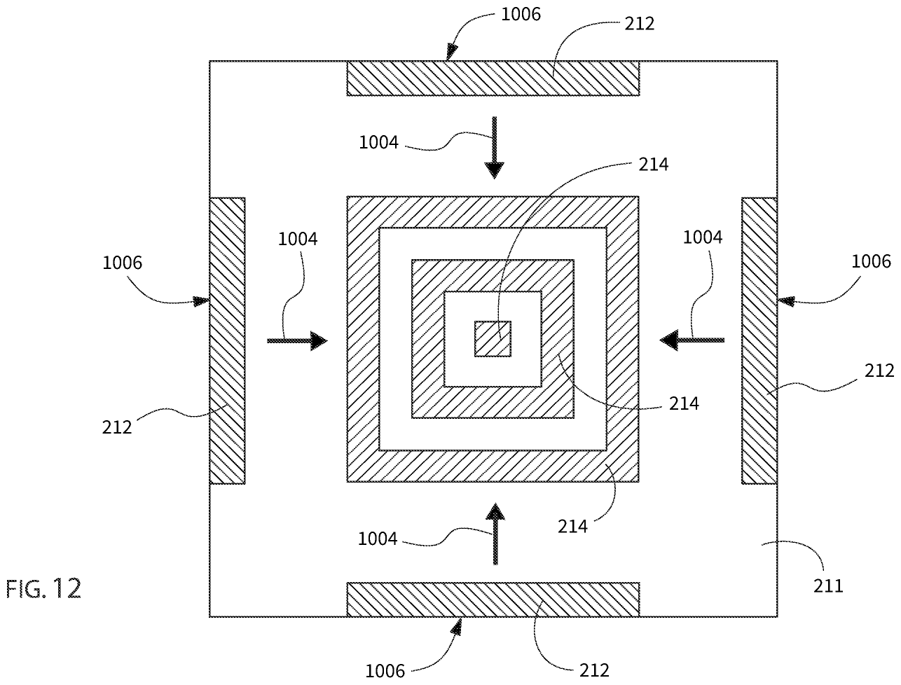

In some embodiments, e.g., as illustrated in FIGS. 12 through 15, the leaked water may enter the substrate 211 at more than one location and may flow along more than one direction 1004, e.g., any two or more of the four directions 1004 illustrated in FIGS. 12 through 15. For example, embodiments such as the exemplary embodiments illustrated in FIGS. 12 through 15 may be provided when the anticipated or most likely leak path includes more than one direction.

As may be seen, for example, in FIG. 12, the leak indicator 210 may include a mobile reactant 212 along multiple edges, such as all four edges in embodiments where the leak indicator 210 is generally rectangular (for instance, has a rectangular cross-section or face, as illustrated in FIGS. 12 through 15), or along all six edges in embodiments where the leak indicator is generally hexagonal (for instance, has a hexagonal cross-section or face), or all eight sides of an octagonal leak indicator 210, etc. In other embodiments, the multiple mobile reactants 212 may be provided along less than all of the edges of the leak indicator 210, for example along two edges of a rectangular leak indicator, along four edges of an octagonal leak indicator, and so forth in various combinations of number of edges and number of mobile reactants. In various embodiments, the leak indicator may be provided in any suitable shape, including the exemplary polygonal shapes mentioned above or any other suitable polygonal shape, a curved shape, e.g., circular or oval, or combinations thereof, such as a shape including both straight linear sides and curvilinear sides or corners, and the mobile reactant or reactants 212 may be provided along or generally parallel to any one or more edges, such either a portion of an edge or an entire edge, and/or combinations thereof.

In such embodiments, at least one immobilized reactant 214 is provided at or approximately at the center of the substrate 211, e.g., at the geometric center of the rectangular face of the substrate 211, or approximately at the geometric center. As used herein, “approximately at the geometric center” means offset from the geometric center in one or more directions by ten percent or less of the length of the (or each) side of the leak indicator 210 which extends along the (or each) offset direction, for example, offset vertically by ten percent or less of a length of a vertical side of the leak indicator (such as ten percent or less of a height H of the leak indicator, as described above in reference to FIG. 9) and/or offset horizontally by ten percent or less of a length of a horizontal side of the leak indicator (for example, ten percent or less of a width W of the leak indicator, as described above in reference to FIG. 9). Further, such embodiments may also include multiple immobilized reactants 214, e.g., multiple instances of the same chemical or substance, at multiple fixed locations on the leak indicator 210. Thus, the multiple immobilized reactants 214 may provide a time indication, e.g., an indication of a time duration of the indicated leak, based on a distance between the multiple fixed locations, in a similar manner as described above with respect to FIGS. 9 through 11.

For example, the multiple immobilized reactants 214 may be provided in a concentric arrangement on the substrate 211, such as the concentric squares illustrated in FIGS. 12 through 15. The multiple immobilized reactants 214 may be arranged in any suitable shape, such as polygonal, oval, circular, or combinations thereof. The multiple immobilized reactants 214 may also be generally concentric, e.g., offset by no more than ten percent of a corresponding dimension (e.g., side length or diameter) of the larger or outer shape of the immobilized reactant in any given direction.

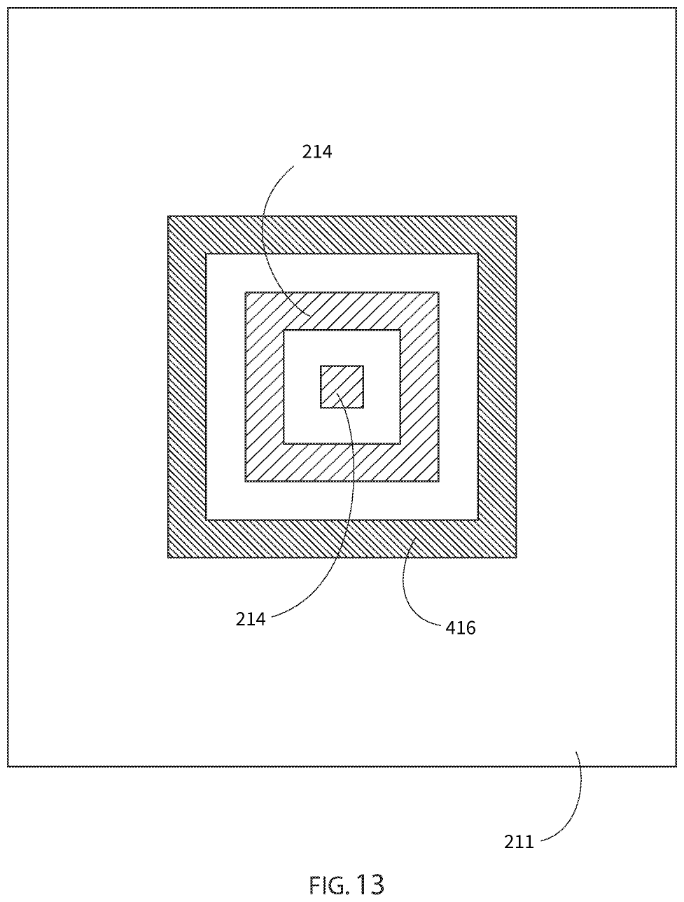

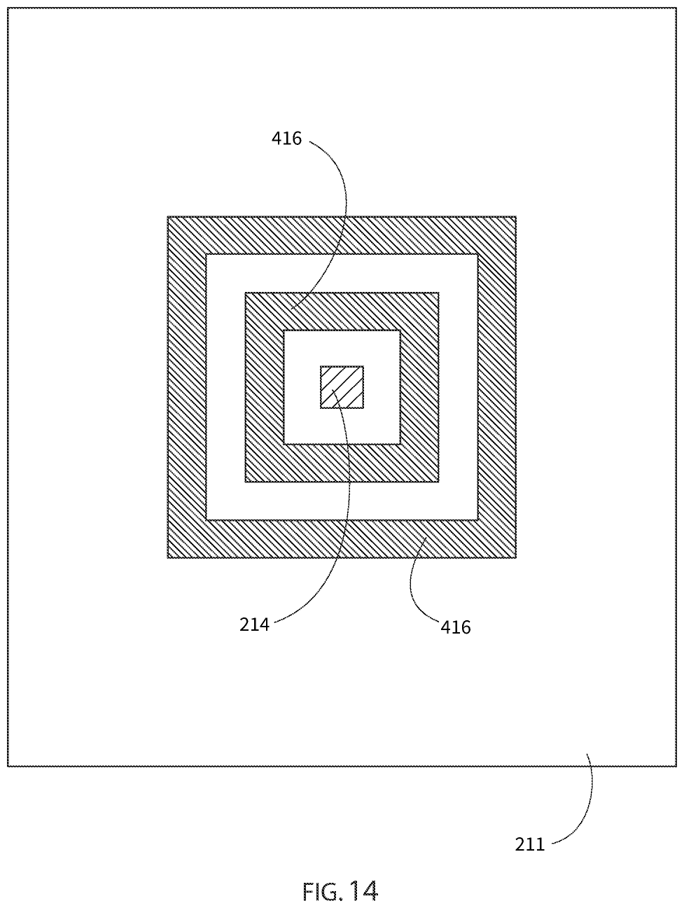

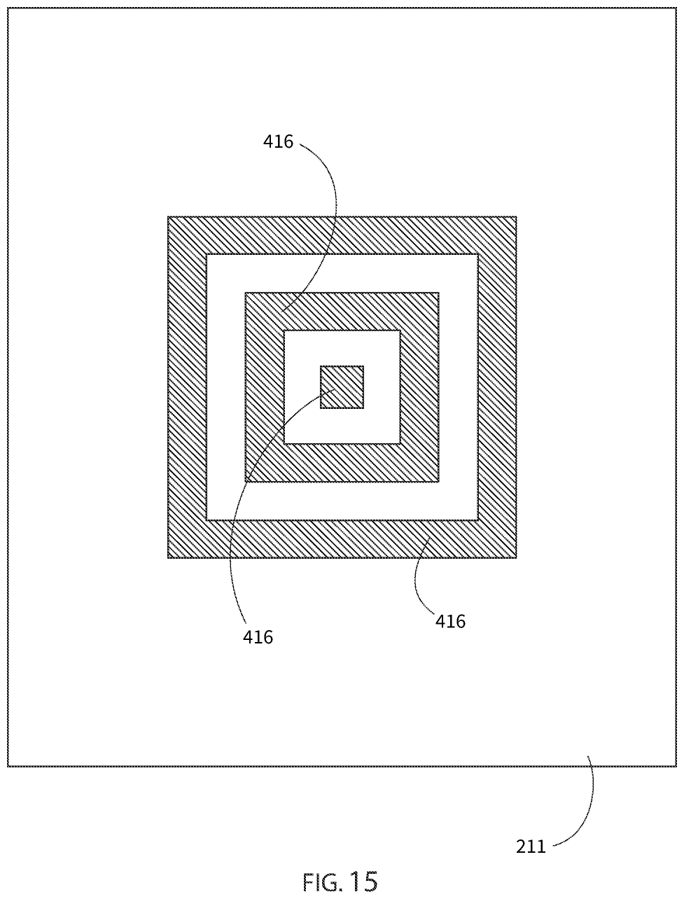

In particular, FIGS. 13 through 15 illustrate a time delay and time indication in a leak indicator 210 comprising three immobilized reactants 214 (e.g., three instances of the same reactant at three fixed locations which are spaced apart from each other along the flow directions 1004). As illustrated in FIG. 13, after a first time duration of the leak has elapsed, the mobile reactant 212 from one or more of the initial locations will reach the first fixed location of the immobilized reactant 214, e.g., after travelling a first distance 300, as described above with respect to FIG. 9. Continuing with FIG. 14, after a second time duration of the leak (which is longer than the first time duration) has elapsed, the mobile reactant 212 from the one or more initial locations which are along the active leak path or paths 1004 will reach the second fixed location of the immobilized reactant 214, e.g., after travelling a second distance 302 which is longer than the first distance 300, where the second distance 302 is also described above with respect to FIG. 9. Further, FIG. 15 illustrates the exemplary leak indicator 210 after a third time duration (which is longer than the second time duration) has elapsed, whereby the mobile reactant 212 from the one or more initial locations which are along the active leak path or paths 1004 will reach the third fixed location of the immobilized reactant 214, e.g., after travelling a third distance 304 which is longer than the second distance 302, and, again, the third distance 304, like the first and second distances 300 and 302, is similar to the third distance 304 described above with respect to FIG. 9.

In various embodiments, any suitable substances may be used as the mobile reactant 212 and the immobilized reactant 214 in order to interact and provide an indication, e.g., a visual indication, of the leak when they interact. For example, in some embodiments, one of the reactants may be phenolphthalein and the other reactant may be potassium hydroxide (KOH) or sodium hydroxide (NaOH), whereby the reactants interact to produce a color change to indicate the leak. In one example embodiment, the mobile reactant 212 may be KOH and the immobilized reactant 214 may be phenolphthalein, whereby the phenolphthalein changes color when the KOH reaches the fixed location of the phenolphthalein and such color change provides a visual indication of the leak. As another example, the reactants may include an acid or base paired with a corresponding pH indicator. In further example embodiments, the interaction of the mobile reactant 212 and the immobilized reactant 214 may also or instead include complexation, oxidation/reduction, or other suitable interactions which produce a detectable product 416 to indicate the presence of the leak.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A household appliance, comprising:
a water filter;
a leak indicator positioned on an external surface of the water filter, the leak indicator comprising:
a substrate comprising a permeable material;
an immobilized reactant embedded in the substrate at a fixed location; and
a mobile reactant disposed at an initial location on the substrate, the initial location of the mobile reactant spaced apart from the fixed location of the immobilized reactant, wherein the mobile reactant is configured to be transported through the substrate by water to the fixed location of the immobilized reactant, wherein the mobile reactant and the immobilized reactant interact to indicate a leak when the mobile reactant reaches the fixed location of the immobilized reactant.

2. The household appliance of claim 1, wherein the immobilized reactant and the mobile reactant are a first pair of reactants spaced apart by a first distance, further comprising a second pair of reactants spaced apart by a second distance, and the second distance is not equal to the first distance.

3. The household appliance of claim 2, wherein the substrate defines a height and a width, wherein the first distance and the second distance are generally parallel to the height of the substrate.

4. The household appliance of claim 2, wherein the water filter comprises an inlet at a proximal end of the water filter, wherein the water filter extends along an axial direction from the proximal end to a distal end opposite the inlet of the water filter, wherein first distance and the second distance are generally parallel to the axial direction.

5. The household appliance of claim 1, wherein the mobile reactant and the immobilized reactant interact by changing colors.

6. The household appliance of claim 1, wherein the immobilized reactant is physically absorbed in the substrate.

7. The household appliance of claim 1, wherein the immobilized reactant is chemically bonded to the substrate.

8. The household appliance of claim 1, wherein a distance between the initial location of the mobile reactant and the fixed location of the immobilized reactant defines an indication delay time of the leak indicator.

9. The household appliance of claim 1, wherein the substrate consists of a single layer of the permeable material, the fixed location of the immobilized reactant is in the single layer, and the initial location of the mobile reactant is in the single layer.

10. The household appliance of claim 1, further comprising an optical sensor, the leak indicator positioned within a field of view of the optical sensor whereby the optical sensor is configured to detect the interaction of the mobile reactant and the immobilized reactant.

11. The household appliance of claim 10, further comprising a light source positioned and configured to emit light onto the leak indicator.

12. The household appliance of claim 10, wherein the leak indicator is configured to indicate a time duration of the indicated leak and the optical sensor is configured to detect the indicated time duration.

13. A leak indicator, comprising:
a substrate comprising a permeable material;
an immobilized reactant embedded in the substrate at a fixed location; and
a mobile reactant disposed at an initial location on the substrate, the initial location of the mobile reactant spaced apart from the fixed location of the immobilized reactant, wherein the mobile reactant is configured to be transported through the substrate by water to the fixed location of the immobilized reactant, wherein the mobile reactant and the immobilized reactant interact to indicate a leak when the mobile reactant reaches the fixed location of the immobilized reactant.

14. The leak indicator of claim 13, wherein the immobilized reactant and the mobile reactant are a first pair of reactants spaced apart by a first distance, further comprising a second pair of reactants spaced apart by a second distance, and the second distance is not equal to the first distance.

15. The leak indicator of claim 14, wherein the substrate defines a height and a width, wherein the first distance and the second distance are generally parallel to the height of the substrate.

16. The leak indicator of claim 13, wherein the mobile reactant and the immobilized reactant interact by changing colors.

17. The leak indicator of claim 13, wherein the immobilized reactant is physically absorbed in the substrate.

18. The leak indicator of claim 13, wherein the immobilized reactant is chemically bonded to the substrate.

19. The leak indicator of claim 13, wherein a distance between the initial location of the mobile reactant and the fixed location of the immobilized reactant defines an indication delay time of the leak indicator.

20. The leak indicator of claim 13, wherein the substrate consists of a single layer of the permeable material, the fixed location of the immobilized reactant is in the single layer, and the initial location of the mobile reactant is in the single layer.
